(19) United States
(12) Patent Application Publication
(10) Pub. No.: US 2011/0309716 A1
(43) Pub. Date: Dec. 22, 2011

(54) FERROELECTRET TWO-LAYER AND MULTILAYER COMPOSITE AND METHOD FOR PRODUCTION THEREOF

(76) Inventors: Werner Jenninger, Koln (DE); Joachim Wagner, Koln (DE); Gunter Walze, Taipai (TW); Dirk Schapeler, Kerpen (DE); Heinz Pudleiner, Krefeld (DE); Gunther Stollwerck, Krefeld (DE); Reimund Gerhard, Berlin (DE); Werner Wirges, Kleinmachnow (DE); Ruy Alberto Altafim, Sao Carlos - SP (BR)

(21) Appl. No.: 12/998,838

(22) PCT Filed: Nov. 28, 2009
(86) PCT No.: PCT/EP2009/008479

§ 371 Date: Sep. 8, 2011

(30) Foreign Application Priority Data
Dec. 13, 2008 (EP) 08021693.0
Jul. 15, 2009 (EP) 09009203.2

(51) Int. Cl. H02N 1/00; B32B 7/08; B32B 38/06; B44C 3/08

(52) U.S. Cl. 310/300; 156/219; 156/92; 156/535

(57) ABSTRACT

The invention relates to a method for producing double or multilayer ferroelectret with defined cavities by: structuring at least one first surface of a first polymer film (1) forming a height profile, applying ate least one second polymer film (5, 1′) to the structured surface on the first polymer film formed in step a), joining the polymer films (1, 1′, 5) to give a polymer film composite with the formation of cavities (4, 4′) and electrically charging of the inner surfaces of the cavities (4, 4′) formed in step c) with opposing electrical charges. The invention further relates to ferroelectret multilayer composites, optionally produced by said method, comprising at least two polymer films, arranged one over the other and connected to each other, wherein cavities are formed between the polymer films. A piezoelectric element comprising a said ferroelectret multilayer composite is also disclosed.

The present invention relates to processes for producing two-layer and multi-layer ferroelectrets with defined voids, and to ferroelectret multi-layer composites produced by these processes.

On account of their advantageous and selectively adjustable properties—such as, for example, low weight, thermal conductivity, mechanical deformability, electrical properties, as well as barrier properties—polymers and polymer composite materials are employed in a large number of commercial applications. For example, they are used as packaging material for foodstuffs or other goods, as construction materials or insulating materials, for example in construction engineering or in automotive engineering. But functional polymers are also gaining in importance to an increasing extent as active components in sensor applications or actuator applications. An important application concept in this connection relates to the use of the polymers as electromechanical or piezoelectric transducers. Piezoelectric materials are capable of linearly converting a mechanical pressure into an electrical voltage signal. Conversely, an electric field applied to the piezoelectric material can be transformed into a change in the transducer geometry. Piezoelectric materials are already integrated as active components in a large number of applications. These components include, for example, structured pressure sensors for keyboards or touchpads, acceleration sensors, microphones, loudspeakers, ultrasonic transducers for applications in medical technology, in marine technology or for materials testing. In WO 2006/053528 A1, for example, an electroacoustic transducer is described which is based on a piezoelectric element consisting of polymer films.

In recent years a new class of piezoelectric polymers, the so-called ferroelectrets, has increasingly been the object of research. The ferroelectrets are also called piezoelectrets. Ferroelectrets consist of polymer materials with a void structure that are able to store electric charges over long periods. The ferroelectrets known hitherto exhibit a cellular void structure and are formed either as foamed polymer films or as multi-layer systems consisting of polymer films or polymer fabrics. If electric charges are distributed in accordance with their polarity on the differing surfaces of the voids, each charged void constitutes an electric dipole. If the voids are now deformed, this gives rise to a change in the magnitude of the dipole and results in a flow of current between outer electrodes. The ferroelectrets may display a piezoelectric activity comparable to that of other piezoelectrics.

In U.S. Pat. No. 4,654,546 a process is described for producing polypropylene expanded films as a preliminary stage towards a ferroelectret film. In this case the polymer films are mixed with filler particles. Titanium dioxide, for example, is employed as filler. The polypropylene films are biaxially stretched after being extruded, so that small voids form in the film around the filler particles. This process has meanwhile also been applied to other polymers. For instance, in M. Wegener, M. Paajanen, O. Voronina, R. Schulze, W. Wirges, and R. Gerhard-Multhaupt “Voided cyclo-olefin polymer films: ferroelectrets with high thermal stability”, Proceedings, 12th International Symposium on Electrets (IEEE Service Center, Piscataway, N.J., USA 2005), 47-50 (2005) and Eetta Saarimäki, Mika Paajanen, Ann-Mari Savijärvi, and Hannu Minkkinen, Michael Wegener, Olena Voronina, Robert Schulze, Werner Wirges and Reimund Gerhard-Multhaupt “Novel Heat Durable Electromechanical Film: Processing for Electromechanical and Electret Applications”, IEEE Transactions on Dielectrics and Electrical Insulation 13, 963-972 (October 2006), the production of ferroelectret films from cyclo-olefin copolymers (COC) and cyclo-olefin polymers (COP) is described. The foamed polymer films have the disadvantage that a broad distribution of the size of the bubbles may arise. As a result, in the course of the subsequent charging step not all the bubbles may be charged uniformly well.

A further process for producing foamed ferroelectret polymer films is the direct physical foaming of a homogeneous film with supercritical liquids, for example with carbon dioxide. In Advanced Functional Materials 17, 324-329 (2007), Werner Wirges, Michael Wegener, Olena Voronina, Larissa Zirkel, and Reimund Gerhard-Multhaupt “Optimized preparation of elastically soft, highly piezoelectric, cellular ferroelectrets from nonvoided poly(ethylene terephthalate) films”, and in Applied Physics Letters 90, 192908 (2007), P. Fang, M. Wegener, W. Wirges, and R. Gerhard, L. Zirkel “Cellular polyethylene-naphthalate ferroelectrets: Foaming in supercritical carbon dioxide, structural and electrical preparation, and resulting piezoelectricity”, this process has been described with polyester materials and also in Applied Physics A: Materials Science & Processing 90, 615-618 (2008), O. Voronina, M. Wegener, W. Wirges, R. Gerhard, L. Zirkel, and H. Müinstedt “Physical foaming of fluorinated ethylene-propylene (FEP) copolymers in supercritical carbon dioxide: single film fluoropolymer piezoelectrets” for a fluoropolymer FEP (fluorinated ethylene-propylene copolymer).

In the case of the ferroelectret multi-layer systems, inter alia arrangements are known consisting of hard and soft layers and charges introduced in between. In “Double-layer electret transducer”, Journal of Electrostatics, Vol. 39, pp. 33-40, 1997, R. Kacprzyk, A. Dobrucki, and J. B. Gajewski, multiple layers are described consisting of solid materials with greatly differing moduli of elasticity. These have the disadvantage that these layer systems display only a relatively low piezoelectric effect.

In several publications from recent years, multi-layer systems are described consisting of closed outer layers and a porous or perforated middle layer. These publications include the articles by Z. Hu and H. von Seggern, “Air-breakdown charging mechanism of fibrous polytetrafluoroethylene films”, Journal of Applied Physics, Vol. 98, paper 014108, 2005 and “Breakdown-induced polarization buildup in porous fluoropolymer sandwiches: A thermally stable piezoelectret”, Journal of Applied Physics, Vol. 99, paper 024102, 2006, and also the publication by H. C. Basso, R. A. P. Altafim, R. A. C. Altafim, A. Mellinger, Peng Fang, W. Wirges, and R. Gerhard “Three-layer ferroelectrets from perforated Teflon-PTFE films fused between two homogeneous Teflon-FEP films” IEEE, 2007 Annual Report Conference on Electrical Insulation and Dielectric Phenomena, 1-4244-1482-2/07, 453-456 (2007) and the article by Jinfeng Huang, Xiaoqing Zhang, Zhongfu Xia, and Xuewen Wang “Piezoelectrets from laminated sandwiches of porous polytetrafluoroethylene films and nonporous fluoroethylenepropylene films” Journal of Applied Physics, Vol. 103, paper 084111, 2008. The layer systems with a porous or perforated middle layer frequently have larger piezoconstants in comparison with the systems described above. In this connection, however, the middle layers may sometimes not be reliably laminated with the solid outer layers. Furthermore, the perforation of the middle layer is, as a rule, very time-consuming.

In the publications by X. Zhang, J. Hillenbrand and G. M. Sessler, “Thermally stable fluorocarbon ferroelectrets with high piezoelectric coefficient”. Applied Physics A, Vol. 84, pp. 139-142, 2006 and “Ferroelectrets with improved thermal stability made from fused fluorocarbon layers”, Journal of Applied Physics, Vol. 101, paper 054114, 2007, and also in Xiaoqing Zhang, Jinfeng Huang and Zhongfu Xia “Piezoelectric activity and thermal stability of cellular fluorocarbon films” PHYSICA SCRIPTA, Vol. T129, pp 274-277, 2007, the structuring of the polymer layers by impressing a metallic grating onto a polymer-layer stack consisting of at least three FEP layers and PTFE layers stacked on top of one another in alternating sequence is described. As a result of the layers being pressed together by the grating at a temperature that lies above the melting-point of FEP and below that of PTFE, the polymer layers are bonded to one another in accordance with the structure of the grating in such a manner that dome-shaped or bubble-shaped voids with a rectangular basal surface are formed between the bars of the grating. This process, however, results in ferroelectrets with differing quality, since the formation of uniform voids can only be controlled with difficulty, especially with an increasing number of layers.

Another process for producing bubble-shaped voids using a grating has been described by R. A. C. Altafim, H. C. Basso, R. A. P. Altafim, L. Lima, C. V. De Aquino, L. Gonalves Neto and R. Gerhard-Multhaupt, in “Piezoelectrets from thermo-formed bubble structures of fluoropolymer-electret films”, IEEE Transactions on Dielectrics and Electrical Insulation, Vol. 13, No. 5, pp. 979-985, 2006. In this case, two Teflon-FEP films arranged above one another are arranged between a metallic grating and an upper cylindrical metallic part. This structure is pressed with the metallic grating onto a lower cylindrical metallic part which exhibits openings for the purpose of applying a vacuum. The FEP films are heated by the upper metallic part, and by means of a vacuum applied to the lower metallic part the lower film is drawn into the openings in the grating and corresponding voids are formed. The processes described, using a grating for the purpose of forming voids in the polymer multi-layer composites, are elaborate and difficult to carry across onto a large scale.

An advantageous simple production method for ferroelectrets with tubular voids of homogeneous size and structure has been described by R. A. P. Altafim, X. Qiu, W. Wirges, R. Gerhard, R. A. C. Altafim, H.C. Basso, W. Jenninger and J. Wagner in the article “Template-based fluoroethylenepropylene piezoelectrets with tubular channels for transducer applications”, which has been accepted for publication in the Journal of Applied Physics. In the process described therein, firstly a sandwich arrangement of two FEP films and a PTFE mask film inserted in between is made available. The film stack that is formed is laminated, the FEP films are bonded to one another, and subsequently the mask film is removed, revealing the voids.

Ferroelectrets are, moreover, of increasing interest for commercial applications, for example for sensor, actuator and generator systems. For economic efficiency in this connection, applicability of a production process on an industrial scale is essential.

The object underlying the invention is therefore to make available alternative ferroelectret multi-layer composites as well as alternative processes for producing ferroelectret multi-layer composites, with which defined ferroelectret void structures can be generated and which can be implemented simply and cost-effectively also on a large industrial scale.

In accordance with the invention, this object is achieved by the process for producing ferroelectret multi-layer composites according to Claim 1 and by a ferroelectret multi-layer composite produced by this process, according to Claim 12 or 13.

In accordance with the invention, a process for producing a ferroelectret two-layer or multi-layer composite with defined voids is proposed that includes the following steps:
a) structuring at least one first surface of at least one first polymer film, forming a height profile,
b) applying at least one second polymer film onto the structured surface of the first polymer film formed in step a),
c) bonding the polymer films to yield a polymer-film composite, forming closed and/or open voids and
d) electrical charging of the inner surfaces of the voids formed in step c) with opposite electric charges.

The two-layer and multi-layer composites produced in accordance with the invention exhibit, in other words, polymer films layered in the form of a stack and voids formed at least between, in each instance, two polymer films. In this connection the polymer films are bonded to one another between the voids. Advantageously, the shape and dimensioning of the voids can, in accordance with the invention, be produced in very precisely predetermined and defined manner. In the process according to the invention, the structuring in step a) and the formation of the height profile on at least one surface of at least the first polymer film are crucial for the formation of the defined voids in the polymer-film composite arising.

It has been found that ferroelectret multi-layer systems with defined void structures can be produced in simple manner with the process according to the invention. With the manner of proceeding according to the invention it is, in addition, possible to adjust resonant frequency and piezoactivity, and in particular the piezoelectric constant d33, variably to the respective application. Advantageously with the ferroelectret multi-layer composite systems produced in accordance with the invention, high and uniform piezoelectric coefficients can also be achieved for larger surface areas. In principle, this opens up numerous applications for these ferroelectret multi-layer composites. An additional advantage is that the processes proposed in accordance with the invention are largely material-independent and capable of being automated.

In principle, the polymer films employed may have been manufactured from any plastic that permits a formation of a height profile, the bonding between the polymer films, and a formation of voids between the films. The polymer films employed may, in accordance with the invention, have been selected from the same or different polymer materials, for example from the group of the polycarbonates, perfluorinated or partly fluorinated polymers and copolymers such as PTFE, fluoroethylene propylene (FEP), perfluoroalkoxyethylenes (PFA), polyesters such as polyethylene terephthalate (PET) or polyethylene naphthalate (PEN), cyclo-olefin polymers, cyclo-olefin copolymers, polyimides, in particular polyether imide, polyethers, polymethyl methacrylate and polypropylene or polymer blends of the above. With these materials, good to very good piezoactivities can be achieved. The wide choice of materials in accordance with the invention can advantageously also enable an adaptation to particular applications.

The polymer films may preferably exhibit a thickness from ≧10 μm to ≦500 μm, particularly preferably from ≧15 μm to ≦300 μm. The thickness of the various polymer films in a ferroelectret multi-layer composite according to the invention may be chosen to be the same or different. A particularly suitable thickness of the polymer films may advantageously be selected in each instance in a manner depending on the polymer material and with regard to the application being striven for. In principle, what matters is that the voids formed in step c) of the process do not collapse. Accordingly, stiffer materials can be made thinner than comparatively more elastic polymer materials.

The polymer films may have been configured as film sheets or, particularly with regard to large-scale production, advantageously also as film webs, which in step b) can be arranged on top of one another and can be bonded to one another in step c), forming the voids. In this connection the film sheets may exhibit, for example, a rectangular, a regular or irregular polygonal shape or a round, for example circular, elliptical or oval, basal surface, in which case the films arranged on top of one another expediently exhibit the same basal surface. In principle, the basal surface may also be adapted to a special application.

In step b) of the process according to the invention, in other words a layered polymer film stack is made available. In this connection, via the chosen total number of the polymer films and the chosen sequence of structured and non-structured polymer films the total height of the polymer-film composite and the number of voids and the number of laminations with voids can be established. The voids between two identical polymer films are understood as being a lamination of voids. In the ferroelectret multi-layer composites according to the invention, two, three or more polymer films with voids situated in between may have been arranged above one another and bonded to one another. In accordance with the invention, in this connection structured and non-structured polymer films may be employed in each instance. These may, for example, be arranged above one another, alternating in the film stack. Alternatively, all the polymer films employed may also exhibit a height profile—that is to say, a structuring. Equally preferably, use may also be made of polymer films that are structured only on one side or only on both sides, or of both types of film in identical or differing number. In principle, in all variants it is preferred that the outward-directed surfaces are compact or non-structured. This can, where appropriate, simplify the placing of electrodes on these outer surfaces of the polymer-film composite. In the case where use is made of bilaterally structured polymer films, for this purpose in addition a non-structured or a unilaterally structured polymer film, for example, may in each instance be arranged in the polymer-film stack at the top and at the bottom by way of terminating film. These terminating films form, as a covering with their non-structured surface, the outer surface of the polymer-film composite which is subsequently formed.

Advantageously, the variants according to the invention in which three or more polymer films, and correspondingly also several laminations of voids, are provided in the ferroelectret multi-layer composite can be made softer in comparison with those with only two polymer films, and by virtue of the additional voids that are present the sensitivity of the composite, and hence the piezoelectric constant d33, can be increased.

In step d), for the electrical charging and polarisation of the inner surfaces of the voids advantageously recourse may be had to known and established methods. A polarisation of the opposing sides of the voids can, for example, be realised by a corona discharge or by plasma processes. A corona treatment is advantageously also capable of being employed well on a large scale.

By virtue of the structuring and formation of the height profile in a polymer film implemented in step a) and the bonding with at least one second polymer film in step b), precisely predetermined voids can be generated and produced in defined manner with the process that is made available. A further advantage is therefore that with the manner of proceeding according to the invention differing resonant frequencies can be avoided such as occur in uncontrolled manner in the case of foamed ferroelectret films by virtue of non-uniform bubbles. In contrast, in accordance with the invention it is even possible also to generate differently configured voids in partial regions of the polymer-film composite arising and hence to adjust differing properties, for example piezoactivities.

In one embodiment, the structuring of the at least one surface of the first polymer film in step a) can be undertaken by an embossing process. Equally preferably, the embossing process can be undertaken using a structured roller or by means of an embossing punch. Both with the use of a structured roller and in the case where a structured embossing punch is employed, in each instance the structure formed on the surface of the embossing tool can be transferred onto a polymer film, forming a height profile. In this connection it is possible to apply positive or negative shapes on the surface of the embossing tool—that is to say, the roller or the embossing punch. The structuring can be undertaken directly after the extrusion of the films or even as an individual process, for example in a hot press. Also encompassed in accordance with the invention is that the respective polymer films can be treated with an embossing tool from both surface sides. For example, a polymer film can be embossed from its upper side and from its underside with, in each instance, a structured roller, and hence can be structured.

In another alternative configuration of the process, the structuring of the at least one surface of the first polymer film in step a) can be undertaken by deformation of an optionally heated polymer film subject to application of pressure, for example with compressed air or with another gas, in a moulding tool with an optionally preheated contoured insert. For example, a polymer film can be heated to a temperature below its softening-temperature (glass transition temperature) and can then be deformed abruptly by the action of compressed air from ≧20 bar to ≦300 bar. For example, polycarbonate films (for example, Macrofol manufactured by Bayer MaterialScience AG) can be heated to 130-140° C., just below the glass temperature. After this, the films can be subjected to an air pressure of 250 bar and pressed onto a moulding tool and can adapt themselves to the contour of the tool and be permanently deformed. In this case the polymer films employed may exhibit, for example, a thickness from ≧10 μm to ≦500 μm, and the depressions and/or elevations that are formed may exhibit a height from ≧10 μm to ≦500 μm and also a width from ≧10 μm to ≦5000 μm. Preferred for the voids is a height from ≧10 μm to ≦250 μm and a width from ≧50 μm to ≦3000 μm. Particularly preferably the voids have a width from ≧100 μm to ≦2000 μm.

An analogous process is already established, in particular, in the case of the repetitively accurate deformation of imprinted plastic films and is described, for example, in German published application DE 39 05 177 A1. A polymer film may in this case be positioned on a pallet system, where required may be heated, and may be deformed in an appropriate moulding tool over a preheated contoured insert by application of pressure. This high-pressure deformation process is also designated as a high-pressure forming (HPF) or as an HPF process. Advantageously in accordance with the invention, an apparatus constructed analogously to that described in DE 39 05 177 A1 may also be employed for the purpose of structuring the polymer films in step a).

All the named structuring variants have the advantage that the transfer of the profile desired in each instance onto the polymer films is made possible in positionally accurate manner. Both the shape and the dimensioning of the voids that are then formed in the next step b) can, with the aforementioned methods, advantageously be chosen almost freely and can be adapted, depending on the film materials and on the properties thereof and on the respective film thickness, to the desired mechanical and electrical requirements of the respective application. The combination of the film properties and the shape and dimensioning of the voids that are formed is chosen in this connection in such a way that the film segments to be kept spaced apart are unable to touch each other in any case of utilisation. The stated structuring methods further have the advantage that they can be automated and can optionally be carried out as a continuous process.

In accordance with the invention, the structuring of the at least one surface of the first polymer film in step a) can also be undertaken by slit extrusion of the polymer film with an appropriately shaped die. For example, by application of this structuring method tube-like or channel-type structures can be formed, and subsequently in a step corresponding voids can be formed. Slit extrusion is advantageously an already established process which, furthermore, can likewise be carried out continuously and in automated manner.

In a ferroelectret multi-layer composite produced in accordance with the invention the voids in the case of a polymer-film thickness from ≧10 μm to ≦500 μm may, for example, exhibit a height from ≧10 μm to ≦500 μm. By ‘height’, in particular the height of the voids in cross-section is meant. Particularly preferably, the voids may exhibit a height from ≧10 μm to ≦250 μm.

The voids can be formed by the process according to the invention in numerous different shapes. The shape of the voids is therefore not limited to a cylindrical, tubular or channel-type shape with a circular or rectangular cross-sectional area perpendicular to the layer progression of the polymer films. Furthermore, the process according to the invention offers the possibility of combining voids that were formed in differing shapes. In this manner, on the one hand the total void volume of the resulting voids can advantageously be maximised. On the other hand, the electromechanical, in particular piezoelectric, properties of the ferroelectret multi-layer composites and electromechanical transducers produced with the process according to the invention can be adapted to their number, arrangement and/or distribution by selection of the shape, size and form of the voids.

The voids may be formed in shapes with a rather small area, such as lines, for example curved or straight, individual or crossed lines or peripheral lines of geometrical shapes, for instance a perimeter of a circle or a peripheral line of a cross, or as structures with a larger area, such as rectangles, circles, crosses, et cetera. The shape and dimensioning of the voids are preferentially adjusted in such a manner that the polymer films cannot touch one another perpendicular to the layer progression thereof within the void and/or that the total void volume resulting after completion is as large as possible. In other words, in particular the positive and negative charges applied by polarisation onto the inner surfaces of the voids should not to be able to touch one another.

The voids may have been formed in shapes that exhibit a cross-sectional area selected from the group consisting of substantially round, for example circular, elliptical or oval, polygonal, for example triangular, rectangular, trapezoidal, rhombic, pentagonal, hexagonal, in particular honeycombed, cruciform, stellate and partly round and partly polygonal, for example S-shaped, cross-sectional areas. The voids in various laminations between the various polymer films in the film stack may in this case be configured identically or differently. This encompasses both the shape, size and form thereof and the number of voids, their arrangement and/or distribution.

The voids within the polymer-film composite that is formed may advantageously make the ferroelectret multi-layer composite to be produced softer along its thickness, hence may lower the modulus of elasticity thereof, and may also enable a polarisation process in the resulting voids.

Within the scope of the process according to the invention, the voids in the polymer-film composite that is formed may be formed in both homogeneously and heterogeneously distributed manner. In particular, depending on the field of application of the ferroelectret multi-layer composite to be produced, it may also be advantageous to form the voids in selectively, positionally resolved and heterogeneously distributed manner.

The bonding of the polymer films to yield a polymer-film composite in step c) may be undertaken in accordance with the invention by, for example, laminating, adhesive bonding, clipping, clamping, screwing, riveting or welding (e.g. laser welding, ultrasonic welding, vibration welding).

The bonding of the polymer films by laminating may be carried out, in particular, thermally, under elevated pressure and/or by means of ultrasound and/or by means of irradiation with ultraviolet light or infrared light. By this means, advantageously the choice of material for the polymer films can be enlarged further. The conditions for the lamination are in this case expediently chosen in such a way that the film layers bond to one another, the structuring of the first polymer film and the height profile thereof, however, are very largely preserved and so a stability of shape and defined formation of the voids are ensured. Prior to being laminated, the material of the first structured polymer film and/or the material of the second polymer film, which also in other words forms a covering of the first film, can be completely hardened, for example completely dried and/or completely crosslinked, and/or completely solidified and/or completely crystallised. By this means, the stability of shape of the polymer-film composite, including voids, arising in accordance with the process can be improved.

The bonding of the polymer films in step c) by means of an adhesive bond may, for example, be undertaken with acrylate adhesive. Alternatively it is also possible, particularly in the case of the bonding of polymer films made of the same material, to achieve the bonding by applying a good solvent or a solvent composition for the respective polymer material onto one or both films, by subsequent compressing of the films and evaporating of the solvent. In other words, at the places and/or in the regions in which the solvent was applied the polymer material is partly dissolved and is hardened again as a result of the evaporation of the solvent and can in this manner serve as an adhesive substance between the polymer films. It is, for example, possible to bond polycarbonate films with methylene chloride by adhesion. An advantage in the case of the bonding by this solvent method is that no thermal loading occurs and precisely in the case of thermally deformable polymer materials the stability of shape can be improved and a collapsing of the voids that are formed can be avoided.

In a further configuration, the polymer films may, in addition to the lamination, also be bonded to one another by means of an adhesive bond. This adhesive bond may, for example, be established by means of acrylate adhesive. By this means, the mechanical bonding of the polymer films can be assisted and improved.

In another configuration of the process, before and/or after the electrical charging of the inner surfaces of the voids in step d) the placing of electrodes on the outer surfaces of the polymer-film composite can be undertaken. The placing of electrodes on the outer surfaces is understood to mean the provision of a conducting surface coating in at least one partial region, in particular on the outward-directed surfaces of the polymer composite. The electrodes are preferably arranged on compact or non-structured surfaces of the polymer films employed.

In accordance with the invention, after the placing of electrodes on the outer surfaces of the ferroelectret multi-layer composite a direct charging can be undertaken by application of an electrical voltage. Prior to the placing of electrodes, a polarisation of the opposing sides of the voids can be realised, for example by means of a corona discharge. A corona treatment is advantageously also capable of being employed well on a large scale. In accordance with the invention, it is also possible firstly to make available a conducting surface coating on a surface, then to charge the polymer composite and finally to apply a second electrode on the opposite outer surface.

In other words, the ferroelectret multi-layer composites produced in accordance with the invention may exhibit, at least partly, a conducting coating on the outward-directed surfaces of the polymer films. These conducting regions can be utilised as electrodes. The conducting coating—that is to say, the electrodes—may in this connection be applied in planar manner and/or also in structured manner. A structured conducting coating may, for example, be configured as an application in strips or in grating form. By this means, additionally the sensitivity of the ferroelectret multi-layer composite can be influenced and can be adapted to particular applications.

In the case of the selected electrode materials it may be a question of conductive materials known to a person skilled in the art. In accordance with the invention, metals, metal alloys, conductive oligomers or polymers, such as, for example, polythiophenes, polyanilines, polypyrrols, conductive oxides, such as, for example, mixed oxides such as ITO, or polymers filled with conductive fillers enter into consideration for this purpose, for example. By way of fillers for polymers filled with conductive fillers, metals, conductive carbon-based materials, such as, for example, carbon black, carbonanotubes (CNTs) or again conductive oligomers or polymers enter into consideration, for example. The filler content of the polymers in this case lies above the percolation threshold, so that the conductive fillers form uninterrupted electrically conductive paths.

The electrodes may be realised by processes known as such, for example by a metallisation of the surfaces, by sputtering, vapour-phase coating, chemical vapour deposition (CVD), printing, doctoring, spin coating, pasting or impressing of a conducting layer in prefabricated form or by a discharge electrode made of a conducting plastic. The electrodes may in this case be configured in structured manner, for example in strips or in grating form. For example, in accordance with the invention the electrodes may also be structured in such a manner that the ferroelectret multi-layer composite exhibits active and passive regions by way of electromechanical transducer. In particular, the electrodes may have been structured in such a manner that, particularly in a sensor mode, the signals can be detected in positionally resolved manner and/or, particularly in an actuator mode, the active regions can be driven selectively. This can be achieved, for example, by the active regions being provided with electrodes, whereas the passive regions exhibit no electrodes.

Also encompassed in accordance with the invention is that two or more ferroelectret multi-layer composites can be bonded with an identically polarised conducting layer—that is to say, electrode. In other words, between two ferroelectret multi-layer composites according to the invention an intermediate electrode can be formed which can be switched to the two electrodes on the then outer surfaces. By this means, the ferroelectret multi-layer composites can be connected in series and the achievable piezoelectric effect can be doubled or multiplied.

The ferroelectret multi-layer composites according to the invention preferably contain two electrodes. In the case of electromechanical transducers according to the invention with more than two electrodes, it may, for example, be a question of stack structures consisting of several ferroelectret multi-layer composite systems, preferentially produced in accordance with the invention.

In another configuration of the process according to the invention, steps a), b), c) and/or d) can be carried out as a continuous roll-to-roll process. Advantageously, the production of the multi-layer composites can accordingly be carried out at least partly as a continuous process, preferentially as a roll-to-roll process. This is particularly advantageous for the application of the processes on a large industrial scale. The automation of at least one part of the production process simplifies the processes and enables the inexpensive production of the ferroelectret multi-layer composites with voids. In accordance with the invention, advantageously all the steps of the process are open to automation.

In one embodiment of the invention, before step b) also the second polymer film may be structured, forming a height profile. By this means, the variability of the ferroelectret multi-layer composites that are capable of being generated can be further increased. Via the chosen total number of polymer films and the chosen sequence of structured and non-structured polymer films, the total height and the number of voids, or number of laminations with voids, can be established. Hence in the ferroelectret multi-layer composites according to the invention two, three or more polymer films with voids situated in between can be arranged above one another and bonded to one another. For example, structured and non-structured polymer films may be arranged above one another, alternating in the film stack. Alternatively, all the polymer films employed may also exhibit a height profile, in which case the films may exhibit an identical or a different structuring relative to one another.

In another configuration, in a further step e) before or after the charging in step d) the sealing of the edges of the polymer-film composite formed in step c) is encompassed. Hence the multi-layer composites according to the invention can advantageously be sealed at the edges in order to protect the latter hermetically against environmental influences, for example in the case of applications in an aggressive environment, for example in atmospheres with high air humidity, or under water.

In a further preferred embodiment of the invention, a gas can be charged into the voids. The gas may be, for example, pure nitrogen (N₂), nitrogen monoxide (N₂O) or sulfur hexafluoride (SF₆). By virtue of the gas charge, advantageously in the case of the ferroelectret multi-layer composites produced in accordance with the invention once again distinctly higher piezoconstants can be achieved by virtue of the polarity.

An immense advantage of the processes according to the invention that are provided, also in their various configurations described above, is that the latter are material-independent within wide ranges and, as a result of this, there is a broad range of application options.

The present invention further provides a ferroelectret multi-layer composite comprising a layer stack consisting of at least one first polymer film and a second polymer film bonded with said first polymer film, whereby at least the first polymer film exhibits, at least on its surface side facing towards the second polymer film, a structuring with elevations and depressions and the first polymer film with its height profile formed by the structuring is bonded with the second polymer film in such a way that one or more voids are formed between the polymer films and, moreover, the inner surfaces of the voids are provided with opposite electric charges.

Within the scope of the present invention, at least some of the voids may have been formed in shapes that exhibit a cross-sectional area in the direction of the layer progression of the polymer films selected from the group consisting of substantially round, for example circular, elliptical or oval, polygonal, for example triangular, rectangular, trapezoidal, rhombic, pentagonal, hexagonal, in particular honeycombed, cruciform, stellate and partly round and partly polygonal, for example S-shaped, cross-sectional areas, and may also have been formed completely in shapes differing therefrom. The geometrical shapes may, moreover, be configured regularly and irregularly.

Independently thereof, the voids perpendicular to the layer progression of the polymer films in the film stack may have been formed partly or totally in shapes that exhibit a cross-sectional area selected from the group consisting of substantially round, for example circular, elliptical or oval, polygonal, for example triangular, rectangular, trapezedoidal, rhombic, pentagonal, hexagonal, in particular honeycombed, cruciform, stellate and partly round and partly polygonal, for example S-shaped, cross-sectional areas, and may also have been formed completely in shapes differing therefrom. The geometrical shapes may, moreover, be configured regularly and irregularly.

In particular, the ferroelectret multi-layer composites according to the invention may exhibit voids that partly or completely have no purely bubble-shaped or dome-shaped form in particular with a rectangular basal surface. The shapes of the voids differing therefrom that are possible in accordance with the invention enable a variable setting of the essential properties of the multi-layer composites arising, such as, for example, of the piezoelectric constants or of the elasticity and softness of the multi-layer composite along its thickness and, by this means, a diverse breadth of application. By virtue of the selection of the voids, in particular of the shapes and dimensioning that are possible in accordance with the invention, and also of the distribution thereof, advantageously the total void volume of the ferroelectret multi-layer composite can be optimised.

The multi-layer composite according to the invention may, for example, also contain more than two polymer films and correspondingly also several laminations of voids which may exhibit identical or differing shape, dimensioning, number and distributions of the voids. Moreover, the multi-layer composite according to the invention may be provided with electrodes. With regard to further features of a ferroelectret multi-layer composite according to the invention, reference is hereby made explicitly to the elucidations in connection with the process according to the invention.

The invention further relates to a ferroelectret two-layer or multi-layer composite with voids, produced by a process according to the invention in accordance with the above description. In this connection the various variants of the production process that are made available and the ferroelectret multi-layer composites resulting therefrom may also optionally be carried out in combination with one another. Such two-layer and multi-layer composites according to the invention exhibit polymer films layered in the form of a stack and voids formed at least between, in each instance, two polymer films. The polymer films are in this case bonded to one another between the voids. Advantageously, the shape and dimensioning of the voids may, in accordance with the invention, be produced in very precisely predetermined and defined manner.

The invention further relates to a piezoelectric element containing at least one ferroelectret multi-layer composite according to the invention and/or at least one ferroelectret multi-layer composite produced by the process according to the invention. This piezoelectric element may, for example, be a sensor element, actuator element or generator element. Advantageously, the invention may be realised in a number of highly diverse applications in the electromechanical and electroacoustic fields, in particular in the field of energy harvesting from mechanical oscillations, acoustics, ultrasound, medical diagnostics, acoustic microscopy, mechanical sensorics, in particular pressure sensorics, force sensorics and/or strain sensorics, robotics and/or communications technology. Typical examples of these are pressure sensors, electroacoustic transducers, microphones, loudspeakers, oscillation transducers, light deflectors, diaphragms, modulators for glass-fibre optics, pyroelectric detectors, capacitors and control systems and “intelligent” floors.

In addition, the invention further encompasses an apparatus for producing ferroelectret multi-layer composites according to the invention. In other words, the invention further relates to an apparatus for implementing the process according to the invention, the apparatus including means for structuring at least one surface of a first polymer film. These means may, for example, be an embossing roller, an embossing punch or a device for deforming by means of application of pressure.

Summing up, processes are provided in accordance with the invention for producing ferroelectret multi-layer composites with voids, which processes can be implemented simply and inexpensively also on a large scale. The ferroelectret multi-layer structures generated with the processes according to the invention can also be produced with a larger number of layers with precisely defined void structure. By virtue of the variable adjustability of the cross-sectional geometry and the dimensioning, the shape and size of the voids, the sequence of layers and number of laminations and also by virtue of the large choice of material for the polymer films employed, the ferroelectrets generated in accordance with the invention can be adjusted particularly well to appropriate fields of application.

The Figures described below are intended to elucidate the invention further in detail without being limited to the embodiments shown and described.

Shown are:

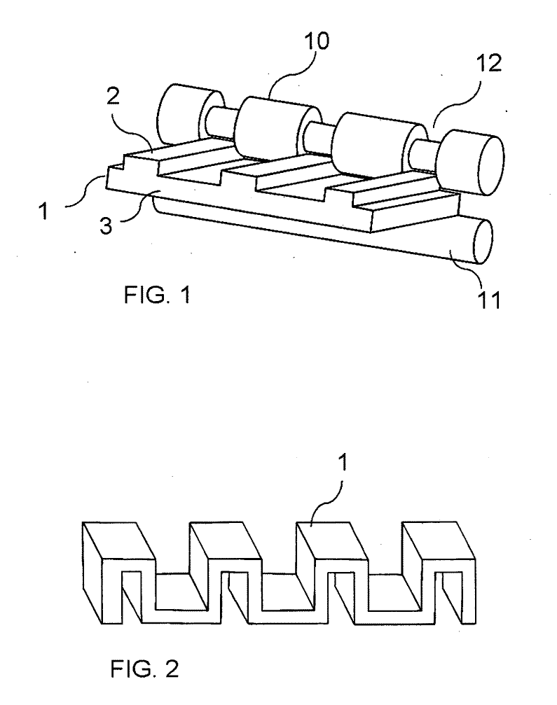

FIG. 1: schematically, the structuring of a first polymer film with a grooved structure on a surface by means of an embossing roller.

FIG. 2: a first polymer film with a grooved structuring introduced on both sides.

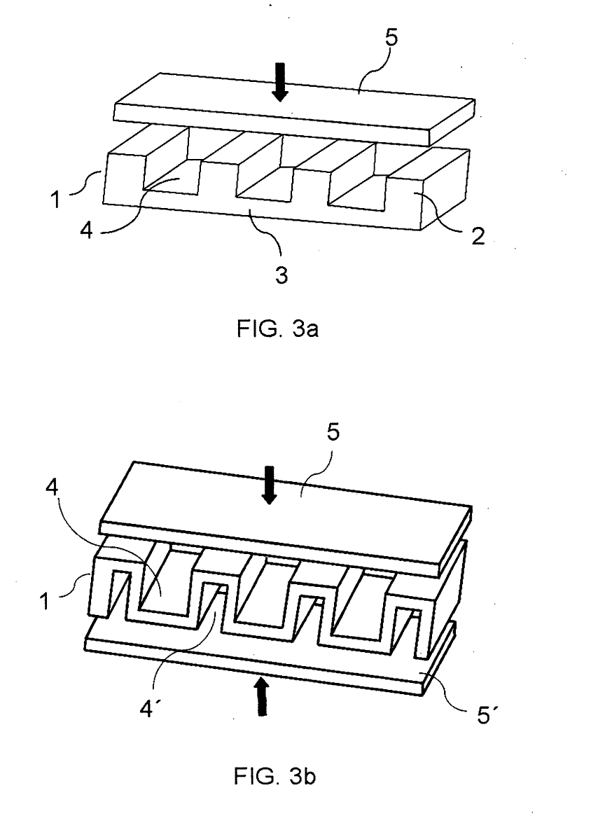

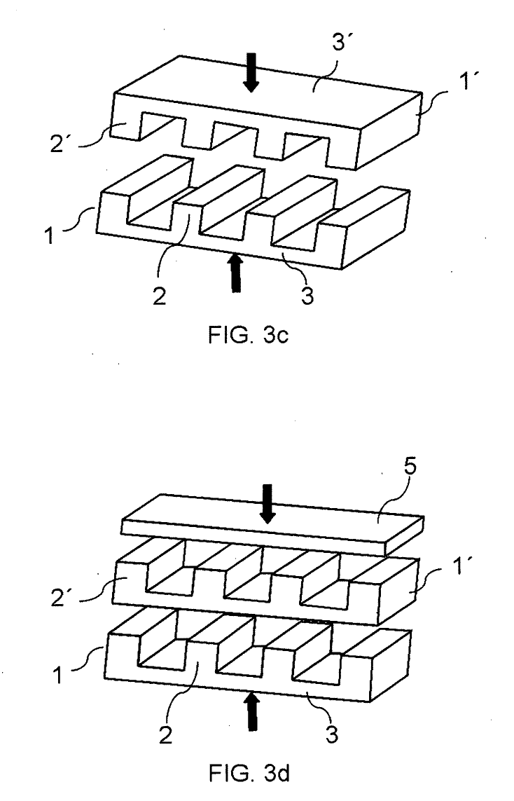

FIG. 3a: in an oblique top view, schematically, the production of a polymer-film composite from a structured film with a second, smooth film.

FIG. 3b: in an oblique top view, schematically, the production of a polymer-film composite from a bilaterally structured film with two non-structured films.

FIG. 3c: in an oblique top view, schematically, the production of a polymer-film composite from a first structured film with a second, equally structured film.

FIG. 3d: in an oblique top view, schematically, the production of a polymer-film composite from two unilaterally structured films with a third, non-structured film.

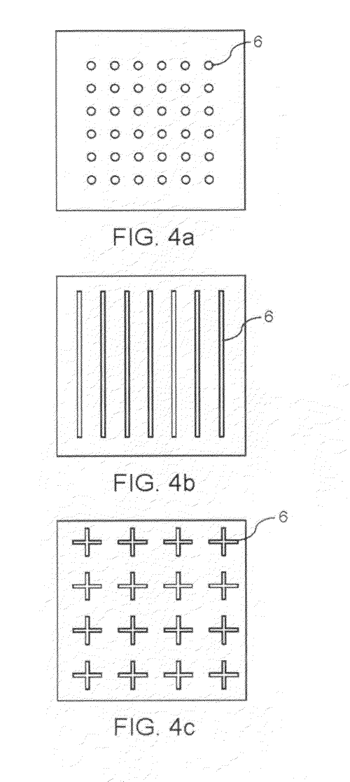

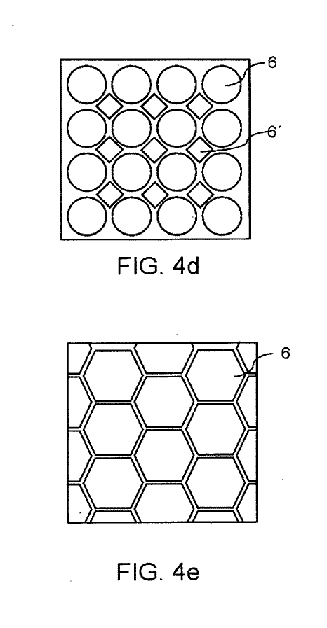

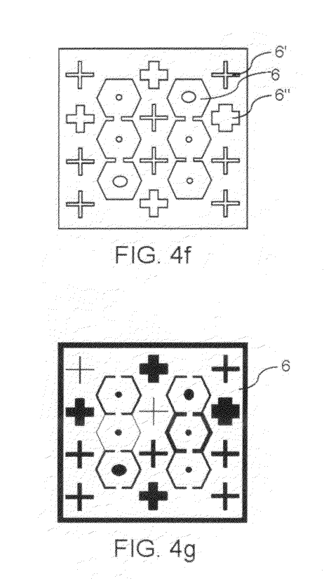

FIGS. 4a to 4g: various shapes of a height profile formed by structuring in a polymer film.

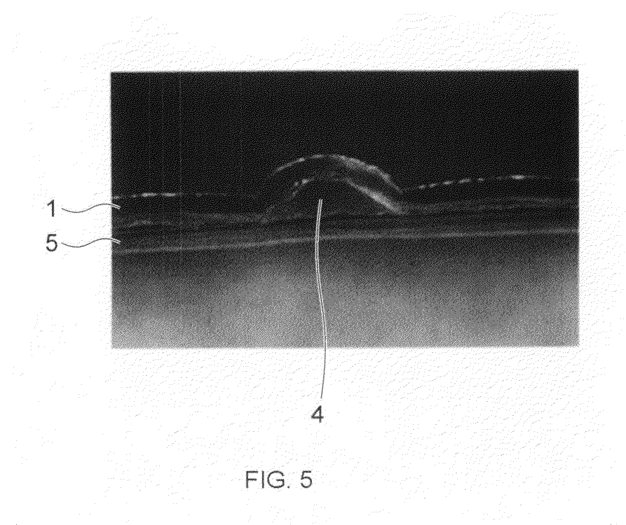

FIG. 5: a magnified micrograph of a ferroelectret multi-layer composite according to the invention consisting of two polycarbonate films.

FIG. 1 shows schematically the structuring of a first polymer film 1 with a grooved structure on a surface by means of an embossing roller 10. By the term “embossing roller 10” a roller is understood which as an embossing tool is able to transfer its structure onto a polymer film. The polymer film 1 may, for example, directly after the extrusion be guided through between the embossing roller 10 and an unstructured guide roller 11. Alternatively, in the apparatus that is used, by way of counterpart for the embossing roller 10 use could also be made of an unstructured plate instead of the guide roller 11. By virtue of the recesses 12 on the embossing roller 10, the corresponding height profile can be formed on the polymer film 1. By virtue of the recesses, a channel-type structuring can be formed on the polymer film, whereby the height profile may be formed by bars 2, arranged in parallel and spaced from one another, on a straight basal surface 3. The shape that is shown of the structuring could, in accordance with a variant according to the invention, also be obtained by slit-die extrusion with an appropriately shaped die. The embossing roller that is employed may advantageously also exhibit other embossing structures which can be appropriately matched to the desired shape of the voids to be formed. In this configuration the basal surface 3 of the polymer film 1 forms on its surface situated opposite the height profile the unstructured second surface of the polymer film 1. In the version that is shown, the bars 2 are configured with perpendicular sides and straight edges. If such a structured polymer film 1 is bonded in accordance with the invention, for example with a non-structured polymer film 5, channel-type voids 4 with a rectangular cross-section can be formed, as represented in FIG. 3a. The grooved structure is not limited to the embodiment shown, and the depressions may, for example, also be formed with a half-round cross-section. In principle, in accordance with the invention there is provision that the outward-directed surfaces of the polymer-film composite ultimately formed are non-structured. Electrodes can then be applied onto these non-structured surfaces before and/or after the polarisation.

FIG. 2 shows a first polymer film 1 with a bilaterally formed grooved three-dimensional structure which, for example, can be introduced by two embossing rollers 10 arranged above one another (not represented here) into the polymer film 1 which is guided through between said rollers. The embossing rollers 10 could in this case be arranged in each instance in interlocking manner with a structure configured in the form of a cylinder. Alternatively, the production of a polymer film 1 bilaterally structured in such a way may be undertaken, for example, also by deformation of an optionally heated polymer film subject to application of pressure in a moulding tool with an optionally preheated contoured insert. In this version of the polymer film 1 the height profile is not placed, as represented in FIG. 1, on a basal surface 3 of the polymer film 1, but the polymer film 1 is three-dimensionally deformed overall. Subsequently voids 4 can be formed by bilateral bonding of the first polymer film 1 with, in each instance, a non-structured film on both surface sides of the polymer film 1, as represented in FIG. 3b. In accordance with the invention it is also possible to fashion the bilateral structuring of the polymer film 1 in such a manner that the height profile is formed on both surfaces, starting from a basal surface 3.

FIG. 3a shows schematically the production of a polymer-film composite according to the invention from a structured polymer film produced analogously to that in FIG. 1 with a second, non-structured polymer film 5. The second polymer film 5 may be arranged on the surface of the polymer film 1 on which the height profile, for example in the form of bars 2, is formed. The voids 4 formed therefrom may exhibit a rectangular cross-section in the embodiment that is represented. The bonding of the two polymer films 1 and 5 can be undertaken in this case by laminating, adhesive bonding, clipping, clamping, screwing, riveting or welding (e.g. laser welding, ultrasonic welding, vibration welding).

FIG. 3b shows schematically the production of a polymer-film composite according to the invention from the bilaterally structured polymer film 1 represented in FIG. 2 with two non-structured polymer films 5 and 5′. The non-structured polymer films 5 and 5′ may in each instance be bonded with the structured polymer film 1 in the arrow direction on a surface side and in each instance form a lamination of voids 4 and 4′ by virtue of the adhesion bonding. In the embodiment that is shown, the voids 4 and 4′ may in each instance exhibit a rectangular cross-section. The voids 4 and 4′ may, in accordance with the invention, be configured in principle in each instance independently of one another in variable shapes and sizes. This also holds for the voids 4 or 4′ in a lamination of the polymer-film composite arising. Understood and designated as a lamination of voids in accordance with the invention are those which are formed between two identical polymer films. The voids within the polymer-film composite that is formed may make the ferroelectret multi-layer composite to be produced advantageously softer along its thickness—that is to say, perpendicular to the layer progression of the polymer films 1, 5, 5′, hence may lower the modulus of elasticity thereof and enable a polarisation process in the resulting voids. The bonding of the two polymer films 1 and 5 may be undertaken in this case by laminating, adhesive bonding, clipping, clamping, screwing, riveting or welding (e.g. laser welding, ultrasonic welding, vibration welding). The polarisation may in principle be undertaken after the bonding of the polymer films, for example by a direct charging by application of an electrical voltage to already placed electrodes. Prior to the placing of electrodes, a polarisation of the opposing sides of the voids can be realised, for example, by a corona discharge or a plasma process.

FIG. 3c shows schematically the production of a polymer-film composite according to the invention from a structured polymer film 1 produced analogously to that in FIG. 1 with a second, similarly structured polymer film 1′. Both polymer films 1 and 1′ exhibit bars 2 on a basal surface 3 by way of height profile. The polymer films 1 and 1′ may in each instance be bonded by their structured surface sides with the bars that are formed. The bars 2 may in this case be placed onto one another in the arrow direction in accurately fitting manner, whereby channel-type voids 4 with a rectangular cross-section may arise perpendicular to the layer progression of the polymer films 1 and 1′. The bonding of the two polymer films 1 and 1′ may in this case be undertaken by laminating, adhesive bonding, clipping, clamping, screwing, riveting or welding (e.g. laser welding, ultrasonic welding, vibration welding).

FIG. 3d shows schematically the production of a polymer-film composite according to the invention from a structured polymer film 1 produced analogously to that in FIG. 1 with a second, similarly structured polymer film 1′ and with a further, non-structured polymer film 5. In accordance with the invention it is possible, as represented, to arrange the second structured polymer film 1′ with its non-structured surface in the arrow direction on the structured surface side of the polymer film 1 and to bond it to the latter. By bonding of the polymer film 1′ with a further polymer film 5, a second lamination of voids can then be formed. In the embodiment that is shown, the structured films 1 and 1′ with the same orientation of the structure are arranged on one another and subsequently bonded to one another. Equally, the structures may also be oriented differently. For example, the structures—in this case, the bars—could be arranged with an angle of 45° or of 90° relative to one another, whereby in accordance with the invention all arrangements at differing angles or orientations of the structures relative to one another are possible. The layer sequence of the polymer films 1 and 1′ may be continued variably with one or more structured and/or non-structured polymer films and may be fashioned variably. Advantageously, the production of a ferroelectret multi-layer composite with several laminations with voids is consequently possible in differing manner and can optionally be adapted to existing polymer films as pre-products or to a planned application and desired properties, such as, for example, modulus of elasticity and piezoelectric constants.

FIGS. 4a-4g show schematic top views of various embodiments of embossing structures in polymer films 1 and hence the possible configuration of the basal surfaces of the corresponding voids at right angles to the layer progression of the polymer films 1. The structures may, for example, be introduced into a polymer film 1 by embossing, in principle as positive or negative shapes—that is to say as depressions or elevations. The embodiments and configurations of the structuring that are shown represent examples only and are not intended to restrict the invention in any form. For reasons of clarity, in FIGS. 4a to 4g in each instance only one recess of a shape is labelled in exemplary manner with a reference symbol.

FIG. 4a shows a structured polymer film 1 comprising depressions 6, the depressions exhibiting a circular basal surface. The depressions 6 may, as illustrated in FIG. 4a, furthermore be formed as a plurality of small depressions 6.

FIG. 4b shows a structured polymer film 1 comprising depressions 6, the depressions 6 exhibiting an elongated, rectangular basal surface.

FIG. 4c shows a structured polymer film 1 comprising depressions 6, the depressions 6 of which exhibit a cruciform basal surface.

FIG. 4d shows a structured polymer film comprising various depressions 6, 6′, the depressions of which exhibit partly a circular basal surface 6 and partly a rhombic basal surface 6′. FIG. 4d illustrates that in the case of a homogeneously distributed arrangement of depressions with circular 6 and rhombic 6′ cross-sectional areas advantageously a particularly large total void volume can be achieved.

FIG. 4e shows a polymer film 1 comprising depressions 6, the depressions 6 of which exhibit a honeycombed basal surface. FIG. 4e illustrates that an advantageously large total void volume can likewise be achieved by virtue of an arrangement that is exclusively based on depressions 6 with honeycombed cross-sectional areas.

FIG. 4f shows a structured polymer film 1 comprising depressions 6, 6′, 6″, the structures of which are formed in differing shape and size and which exhibit cruciform 6′, 6″ and substantially honeycombed surfaces 6. FIG. 4f shows, moreover, that the depressions 6, 6′, 6″ may be formed in non-homogeneously distributed manner and partly connected to one another.

FIG. 4g shows a polymer film 1 comprising depressions 6, the depressions 6 of which are formed by applying a combination of differing structures, in particular hexagons/honeycombs, crosses and dots of differing dot thickness and line thickness. FIG. 4g shows, moreover, that at least the marginal regions of the uninterrupted polymer layer may be formed with a closed structure, in order after conclusion of the production process according to the invention to obtain one or more sealed voids in contact with the uninterrupted polymer layers. In this manner a coherent void can be formed. FIG. 4g illustrates, moreover, that within the scope of the present invention by the expression “a structured polymer film 1 with height profile” a polymer film may also be understood that exhibits only one depression 6, in which case the latter may also be understood as an amalgamation or connection of several depressions.

FIG. 5 shows a magnified micrograph of a ferroelectret multi-layer composite according to the invention, consisting of two polycarbonate films in cross-section. The structured polymer film 1, a polycarbonate film (Makrofol Bayer MaterialScience AG) with a thickness of 75 μm, was for this purpose heated to 130-140° C., just below the glass temperature. After this, the polycarbonate film 1 was pressed with an air pressure of 250 bar onto the moulding tool with a groove profile. By means of the moulding tool, the polycarbonate film 1 was deformed in such a manner that semicylindrical depressions formed. On the opposite surface of the polymer film 1 in this case the structure was formed correspondingly as a semicylindrical height profile. Onto the structured polycarbonate film 1 on the surface side, which exhibited the depressions by way of structure, a smooth polycarbonate film 5 of 75 μm thickness was placed and was bonded to the first by laminating. By this means, voids 4 resulted having a semicircular cross-section perpendicular to the layer progression of the polymer films 1 and 5. In cross-section the voids 4 had a height of 100 μm. The compact outer surface of polymer film 1, exhibiting the elevation, and also the outward-directed non-structured surface of polymer film 5, were subsequently provided in each instance with an aluminium electrode of 50 nm thickness. The polarisation of the inner voids 4 was undertaken by means of directly applied electrical voltage. The composite that was generated displayed a good piezoactivity which was comparable to the piezoactivity of the specimens obtained in accordance with Example 5.

The invention is to be elucidated further by the Examples cited in the following, without being restricted thereto.

### EXAMPLES

### Example 1

Production of a Lubricant-Additive Master Batch

Production of the lubricant-additive compound with conventional twin-screw compounding extruders (e.g. ZSK 32) at customary processing temperatures for polycarbonate from 250° C. to 330° C.

A master batch with the following composition was produced:
polycarbonate Makrolon 2600 000000 manufactured by Bayer MaterialScience AG with a proportion of 98 wt. %
di-isopropyl dimethylammonium perfluorobutane sulfonate as colourless powder with a proportion of 2 wt. %

### Example 2

Film Extrusion:

A compound of the following composition was blended:
lubricant-additive master batch according to Example 1 with a proportion of 20 wt. % and polycarbonate Makrolon 2600 manufactured by Bayer MaterialScience AG with a proportion of 80.0 wt. %

The plant used for the production of the films consists of
a main extruder with a screw of 105 mm diameter (D) and with a length of 41×D; the screw exhibits a degassing zone;
an extrusion slit die of 1500 mm width;
a three-roller smoothing calender with horizontal roller arrangement, the third roller being capable of swivelling by +/−45° in relation to the horizontal;
a roller track;
a device for bilateral application of protective films;
a take-off device;
wind-up station.

The granulate was supplied to the filling funnel of the extruder. In the plasticising-system cylinder/screw of the extruder the fusing and conveying of the material were undertaken. The melt of material was supplied to the smoothing calender, the rollers of which exhibited the temperature stated in Table 1. On the smoothing calender (consisting of three rollers) the definitive shaping and cooling of the film were undertaken.

TABLE 1

| Process parameter | | |
|---|---|---|
| Temperature of the main extruder | 275° C. +/− 5° C. | |
| Temperature of the co-extruder | 260° C. +/− 5° C. | |
| Temperature of the deflection head | 285° C. +/− 5° C. | |
| Temperature of the die | 300° C. +/− 5° C. | |
| Speed of the main extruder | 45 | min⁻¹ |
| Speed of the co-extruder | 12 | min⁻¹ |
| Temperature of rubber roller 1 | 24° | C. |
| Temperature of roller 2 | 72° | C. |
| Temperature of roller 3 | 131° | C. |
| Take-off speed | 21.5 | m/min |

For the purpose of unilateral structuring of the surface of the film, in this case a rubber roller was employed at a first position in the plant that was used. The rubber roller that was used for the structuring of the surface of the film is disclosed in patent specification U.S. Pat. No. 4,368,240 held by Nauta Roll Corporation.

At a second position in the plant a metal roller structured with an advanced-compound-parabolic concentrator (ACPC) structure was employed. The ACPC structure was employed with the following parameters: acceptance angle: 8°, shortening-factor: 0.05.

The compound-parabolic-concentrator (CPC) region of the structure was able to be determined by:
a) calculating the aperture angles in the medium θ₁ and θ₂ from the Fresnel equations by means of the defined acceptance angle;
b) construction of the two parabola branches P₁ and P₂ with the aperture angles in the medium θ₁ and θ₂ in accordance with the following equation:

$${y}_{1 , 2} = \frac{{( x ∓ cos {θ}_{1 , 2} )}^{2}}{2 ( 1 ∓ sin {θ}_{1 , 2} )} - \frac{1 \pm sin {θ}_{1 , 2}}{2}$$

where θ_{1,2} is the aperture angle in the medium of the left (θ₁) and right (θ₂) parabolas, x is the X-coordinate, and y_{1,2} is the Y-coordinate of the left (y₁) and right (y₂) parabolas;
c) calculation of the end-points of the parabola branches F₁, F₂ and E₁, E₂;
d) rotation of the parabolas about the aperture angle in the medium—θ₁ and θ₂ and translation of parabola P₂ along the x-axis;
e) optionally in the case of an asymmetrical variant with θ₁≠θ₂ the determination of the inclination of the inclined surface defined by points E₁ and E₂;
f) determination of the effective acceptance angle in air from the geometry constructed in steps a) to e);
g) comparison of the effective acceptance angle with the defined acceptance angles, and in the case of a deviation greater than 0.001% repetition of steps a) to f) with corrected acceptance angles instead of the defined acceptance angles in step a), the corrected acceptance angles being unequal to the defined acceptance angles, and the corrected acceptance angles being chosen in such a way that the effective acceptance angles from step f) coincide with the defined acceptance angles; and
h) upon attaining a deviation of the effective acceptance angles from the defined acceptance angles of 0.001% or less, shortening of the parabolas in the y-direction to the dimension determined by the shortening-factor.

The construction description cited above has been kept so general that the roller having ACPC structure may in principle also be produced from various materials (medium 1: for example PMMA or polycarbonate). Furthermore, the ACPC region may be employed in various environments (medium 2: e.g. air or water). That is to say, medium 1 and medium 2 with their refractive indices then enter into the stated Fresnel equations.

Subsequently the embossed film was transported by a take-off. After this, a protective film consisting of polyethylene was able to be applied on both sides, and a winding-up of the film was able to be undertaken. A film with 180 μm thickness of the base layer was obtained, on which on the one side the ACPC structure was embossed and on the other side a texturing with a depth of roughness R₃z of 8 μm. The height of the ACPC structure, starting from the base layer, was 73 μm and the spacing was 135 μm. In other words, a valley-to-valley spacing of 135 μm arises, and in the perpendicular a spacing from valley to vertex of the peak of 73 μm.

### Example 3

Production of a ferroelectret multi-layer composite from a first film structured by means of roller and from a smooth polycarbonate film with 20 μm thickness:

A smooth, 20 μm thick polycarbonate film was placed onto the structured side of a polycarbonate film provided with the ACPC roller profile, as described in Example 1, with a thickness of 285 μm. This film composite was then laminated at 205° C. After the laminating the film composite exhibits a layer thickness of 285 μm. Following the depth profile of the film with roller profile, voids form in the polymer-film composite of the two polycarbonate films. In cross-section these voids have a height of 40 μm and a width of 25 μm. The spacing of the voids is predetermined by the embossed roller profile. In the course of the laminating process, however, the roller profile is somewhat flattened, so that the voids turn out to be smaller than the height of the original roller profile predetermines. As a result, the total thickness of the layer stack becomes smaller than the sum of the layer thicknesses of the individual films prior to the laminating process. The film composite was subsequently provided on both surfaces with aluminium electrodes of 50 nm thickness. The polarisation of the inner voids was undertaken by means of directly applied electrical voltage from 17 kV to 19 kV. The piezoelectric effect was measured directly after the polarisation.

For the polarisation with 17 kV the measurements yielded a d33 coefficient of 4 pC/N directly after the polarisation, and for the polarisation with 19 kV a d33 coefficient of 5 pC/N resulted. For each specimen five measurements were carried out, and the mean value was formed.

### Example 4

Production of a ferroelectret multi-layer composite from a polycarbonate film with roller profile and from a smooth polycarbonate film of 50 μm thickness:

A smooth, 50 μm thick polycarbonate film was placed onto the profiled side of a film provided with the roller profile analogously to Example 1 with a total thickness of 285 μm. This film composite was then laminated at 205° C. After the laminating, the film composite exhibits a thickness of 320 μm. Following the depth profile of the film with roller profile, triangular voids form in the polymer-film stack. These voids have a depth of about 40 μm and a width of 60 μm. The spacing of the voids is predetermined by the embossed roller profile. In the course of the laminating process the 50 μm thick polycarbonate layer is pressed into the roller profile, so that the voids turn out to be smaller than the height of the original roller profile predetermines. As a result, the total thickness of the polymer-film composite is smaller than the sum of the layer thicknesses of the individual films prior to the laminating process. The film composite was subsequently provided on both surfaces with aluminium electrodes of 50 nm thickness. The polarisation of the inner voids was undertaken by means of directly applied electrical voltage of 20 kV. The piezoelectric effect was measured directly after the polarisation. According to this Example, four specimens measuring 4 cm×4 cm were produced and were each gauged five times.

For the measurements directly after the polarisation, the mean values resulted that are presented in Table 2.

TABLE 2

| Specimen | 1 | 2 | 3 | 4 |
|---|---|---|---|---|
| d33 | 6 | 3 | 8 | 6 |
| | pC/N | pC/N | pC/N | pC/N |

### Example 5

Production of a ferroelectret multi-layer composite from two polycarbonate films structured by means of embossing roller:

The profiled sides of two films provided with the roller profile, in each instance with a total thickness (basal surface and structure) of 285 μm, were placed onto one another in such a way that the embossed structures intersect. This film composite was then laminated at 205° C. After the laminating, the film composite exhibits a layer thickness of 550 μm. Following the depth profile of the films with roller profile, voids form in the layer stack. The voids were gauged 45° relative to the intersected structure and in cross-section have a height of about 50 μm and a width of 100 μm. The spacing of the voids in the course of the gauging at 45° amounts to 190 μm. In the course of the laminating process the roller profile was flattened, so that the dimensions of the voids turned out to be smaller than the height of the original roller profile predetermined. As a result, the total thickness of the layer stack was smaller than the sum of the layer thicknesses of the individual films prior to the laminating process. The film composite was subsequently provided on both outward-directed surfaces with aluminium electrodes of 50 nm thickness. The polarisation of the inner voids was undertaken by means of directly applied electrical voltage of 20 kV. The piezoelectric effect was measured directly after the polarisation. According to this example, nine specimens measuring 4 cm×4 cm were produced and gauged. In each instance five measurements of the piezoelectric constants were carried out, and the mean value was formed therefrom.

For the measurements directly after the polarisation, the values resulted that are presented in Table 3.

TABLE 3

| Speci- | | | | | | | | | |
|---|---|---|---|---|---|---|---|---|---|
| men | 1 | 2 | 3 | 4 | 5 | 6 | 7 | 8 | 9 |
| d33 | 4 | 4 | 12 | 22 | 4 | 10 | 6 | 14 | 3 |
| | pC/N | pC/N | pC/N | pC/N | pC/N | pC/N | pC/N | pC/N | pC/N |

### Example 6

Production of a ferroelectret multi-layer composite from a first film structured by means of application of pressure in a moulding tool and from a smooth polycarbonate film.

A polycarbonate film (Makrofol Bayer MaterialScience AG) with a thickness of 75 μm was heated to 130-140° C., just below the glass temperature. After this, the polycarbonate film was pressed with an air pressure of 250 bar onto the moulding tool with a groove profile. The polycarbonate film adapted itself to the contour of the tool and was permanently deformed in grooved manner. The film was in this case deformed in its totality, so that a height profile arose on one surface and correspondingly grooved depressions arose on the other surface side of the polycarbonate film. Onto this structured polycarbonate film a smooth polycarbonate film of 75 μm thickness was placed and was bonded to the first by laminating. Voids arose having a semicircular cross-section, perpendicular to the layer progression of the polymer films. In cross-section the voids had a height of 100 μm. The film composite was subsequently provided on both surfaces with aluminium electrodes of 50 nm thickness. The polarisation of the inner voids was undertaken by means of directly applied electrical voltage. The composite that was generated displayed a good piezoactivity which was comparable to the piezoactivity of the specimens obtained in accordance with Example 5. A magnified detail of the polymer-film composite in the region of a void is shown in FIG. 5.

### Example 7

Ferroelectret multi-layer composite consisting of a polycarbonate film with embossing-punch profile and of a smooth polycarbonate film of 125 μm thickness

An embossing punch made of aluminium was provided with a groove structure. In this connection the grooves have a spacing of 1 mm, a depth of 80 μm. Into this embossing punch a polycarbonate film (Makrofol DE 1-1, 125 μm thickness) was pressed in a hot press, so that the groove structure was raised on the polycarbonate film in the form of a height profile. Onto a second polycarbonate film (Makrofol DE 1-1, 125 μm thickness) an Apec 1800 solution in mesitylene, 1 methoxy-2-propanolacetate, 1,2,4-trimethylbenzene, ethyl-3-ethoxypropionate, cumene and solvent naphtha was applied with a doctor blade. Subsequently the two films were pressed gently onto one another until the solvents were evaporated, and in this manner were bonded to one another. The composite generated was provided with electrodes on the outward-directed surfaces, and the inner voids 4 were polarised. The polymer-film composite displayed a good piezoactivity which was comparable to the piezoactivity of the specimens obtained in accordance with Example 5.

Test format for the mechanical measurement of the d33 piezoconstants of the ferroelectret multi-layer composite systems produced, and implementation of the measurements

For the measuring device, in principle the following three main components are needed: force-generator, force-measuring instrument and charge-measuring instrument. By way of force-generator, an electrical oscillation-exciter, type 4810 manufactured by Brüel & Kjaer, was chosen. The oscillation-exciter makes it possible to exert a defined force depending on the input voltage. This oscillation-exciter was mounted on a mobile platform, the position of which in the vertical direction is manually adjustable. The adjustability in height of the oscillation-exciter is necessary for the purpose of clamping the specimens. In addition, the static preliminary pressure, which is required for the measurement, can be adjusted thereby. For the purpose of controlling the oscillation-exciter, a function-generator DS 345 manufactured by Stanford Research Systems was utilised in conjunction with a power-amplifier, type 2718 manufactured by Brüel & Kjaer. By way of force-measuring instrument, use was made of a force-sensor, type 8435 manufactured by Burster. The force-sensor is designed both for pressure measurements and for tension measurements within the range from 0 N to 200 N. The action of force may, however, only be effected perpendicularly, so that no lateral force components or torques act on the sensor. In order to guarantee this, the force-sensor was provided with a cylindrical pressure-guidance rail with a bolt made of stainless steel sliding therein in almost frictionless manner. At the free end of the bolt there was located a polished plate, two centimetres wide, which served as bearing surface for the specimens. The signals from the force-sensor are registered with a modular amplifier, type 9243 manufactured by Burster, and are passed to an oscilloscope, GOULD 4094.

By way of charge-measuring instrument, use was made of a charge-amplifier, type 2635 manufactured by Brüel & Kjaert. The charge-amplifier makes it possible to register charges up to 0.1 pC. For the measurement of the surface charge, the two sides of the specimen have to be electrically connected to the charge-amplifier. The electrical contact with the lower side of the specimen is made possible by the bearing surface, which in turn is connected to the entire structure. The upper side of the specimen was connected to the charge-amplifier by means of the pressure-exerting punch made of brass. The punch is electrically insulated from the remaining structure by an attachment made of plexiglass on the oscillation-exciter and is connected to the charge-amplifier by means of a cable.

The cable should be as thin and soft as possible, in order to avoid mechanical stresses and hence falsifications of the results of measurement. The measured signal is finally passed from the charge-amplifier to the oscilloscope. As standard, a preliminary pressure of 3 N (static) was set and was measured with an amplitude of 1 N (dynamic).

What is claimed is:

1. Process for producing a ferroelectret two-layer or multi-layer composite with voids, characterised by the following steps:
a) structuring at least one first surface of a first polymer film (1), forming a height profile,
b) applying at least one second polymer film (5, 1′) onto the structured surface of the first polymer film formed in step a),
c) bonding the polymer films (1, 1′, 5) to yield a polymer-film composite, forming voids (4, 4′) and
d) the electrical charging of the inner surfaces of the voids (4, 4′) formed in step c) with opposite electric charges.

2. Process according to claim 1, characterised in that the structuring of the at least one surface of the first polymer film (1) in step a) is undertaken by an embossing.

3. Process according to claim 2, characterised in that the embossing is undertaken using a structured roller.

4. Process according to claim 2, characterised in that the embossing is undertaken using a structured embossing punch.

5. Process according to claim 1, characterised in that the structuring of the at least one surface of the first polymer film (1) in step a) is undertaken by deformation of the optionally heated polymer film (1) subject to application of pressure in a moulding tool with an optionally preheated contoured insert.

6. Process according to claim 1, characterised in that the structuring of the at least one surface of the first polymer film (1) in step a) is undertaken by slit extrusion of the polymer film with a shaped die.

7. Process according to claim 1, characterised in that the bonding of the polymer films to yield a polymer-film composite in step c) is undertaken by laminating, adhesive bonding, clipping, clamping, screwing, riveting or welding (e.g. laser welding, ultrasonic welding, vibration welding).

8. Process according to claim 1, characterised in that before and/or after the electric charging of the inner surfaces of the voids in step d) the placing of electrodes on the outer surfaces of the polymer-film composite is undertaken.

9. Process according to claim 1, characterised in that steps a), b), c) and/or d) are carried out as a continuous roll-to-roll process.

10. Process according to claim 1, characterised in that it includes by way of further step e) before or after the charging in step d) the sealing of the edges of the polymer-film composite formed in step c).

11. Process according to claim 1, characterised in that it includes by way of further step f) before the polarisation in step d) the charging of a gas into the voids in the polymer-film composite.

12. Ferroelectret two-layer or multi-layer composite comprising a layer stack consisting of at least one first polymer film (1) and a second polymer film (1′, 5) connected to said first polymer film, characterised in that at least the first polymer film (1) exhibits at least on its surface side facing towards the second polymer film (1′, 5) a structuring with elevations and depressions and the first polymer film (1) is bonded to the second polymer film (1′, 5) in such a manner that one or more voids (4) are formed between the polymer films (1)(1′, 5) and furthermore the inner surfaces of the voids (4) that are formed are provided with opposite electric charges.

13. Ferroelectret two-layer or multi-layer composite according to claim 12, characterised in that the shape of the cross-sectional areas of the voids parallel and perpendicular to the layer progression of the polymer films are selected, independently of one another, partly or totally from regular and irregular, round, elliptical or oval, polygonal, honeycombed, cruciform, stellate and partly round and partly polygonal shapes.

14. Piezoelectric element containing at least one ferroelectret two-layer or multi-layer composite according to claim 12 and/or at least one ferroelectret two-layer or multi-layer composite produced by a process according to claim 1.

15. Apparatus for implementing the process according to claim 1, characterised in that it includes means for structuring at least one surface of a first polymer film.
